(19) United States
(12) Patent Application Publication
(10) Pub. No.: US 2010/0193270 A1
(43) Pub. Date: Aug. 5, 2010

(54) HYBRID ELECTRIC PROPULSION SYSTEM

(76) Inventors: Raymond Deshaies, Montreal (CA); Marcel Chartrand, Rosemere (CA)

Correspondence Address: GOUDREAU GAGE DUBUC, 2000 MCGILL COLLEGE, SUITE 2200, MONTREAL, QC, H3A 3H3, CA

(21) Appl. No.: 12/665,268

(22) PCT Filed: Jun. 23, 2008
(86) PCT No.: PCT/CA2008/001223

§ 371 Date: Dec. 17, 2009

Related U.S. Application Data
(60) Provisional application No. 60/945,467, filed on Jun. 21, 2007.

(51) Int. Cl. B60W 10/04; F16F 15/30; B60W 20/00; H02K 7/02

(52) U.S. Cl. 180/65.265; 74/572.11; 318/150; 180/65.21

(57) ABSTRACT

A hybrid electric propulsion system for a vehicle. The system includes an internal combustion engine (12); a flywheel (14) operatively connected to the engine (12), the flywheel (14) having a horizontal rotation axis parallel to a rotation axis of the wheels of the vehicle, the flywheel (14) having a main disk being rotatable in an opposite direction (R_{FES}) with respect to a rotation of the wheels (R_{T}) of the vehicle when the vehicle is travelling forward so as to inhibit a rollover effect of the vehicle when the vehicle is turning; an electric generator (18) operatively connected to the flywheel (14); an electric motor (22) operatively connected to the electric generator (18); and a controller for controlling operation of the engine (12), the flywheel (14), the electric generator (18) and the electric motor (22).

### FIELD OF THE INVENTION

The present invention relates to a hybrid electric propulsion system for vehicles.

### BACKGROUND OF THE INVENTION

Flywheel energy storage systems work by accelerating a rotor to a very high speed and maintaining the energy in the system as inertia energy. The adaptation of flywheels in vehicles has been put aside by developers due to technical difficulties which have not been resolved. In particular, the problems of flywheels associated with its gyroscopic and rollover effects in vehicles has not been suitably addressed.

### SUMMARY OF THE INVENTION

According to the present invention, there is provided a hybrid electric propulsion system for driving at least one traction wheel of a vehicle, the system comprising:
an internal combustion engine;
a flywheel operatively connected to the internal combustion engine for storing mechanical kinetic energy, the flywheel having a horizontal rotation axis parallel to a rotation axis of the wheels of the vehicle, the flywheel having a main disk being rotatable in an opposite direction with respect to a rotation of the wheels of the vehicle when the vehicle is travelling forward so as to inhibit a rollover effect of the vehicle when the vehicle is turning;
an electric generator operatively connected to the flywheel;
an electric motor operatively connected to the electric generator;
a controller for controlling operation of the engine, the flywheel, the electric generator and the electric motor.

According to another aspect of the present invention, there is provided a hybrid electric propulsion system for driving at least one traction wheel of a vehicle, the system comprising:
an internal combustion engine;
at least one flywheel operatively connected to the internal combustion engine for storing mechanical kinetic energy;
an electric generator operatively connected to the flywheel;
a first alternator having first field coils for controlling a magnetic field of the electric generator;
an electric motor operatively connected to the electric generator;
a second alternator having second field coils for controlling a magnetic field of the electric motor; and
a controller for controlling in cascade a first current in the first field coils of the first alternator and a second current in the second field coils of the second alternator.

The invention as well as its numerous advantages will be better understood by reading the following non-restrictive description of preferred embodiments made in reference to the appended drawings.

### BRIEF DESCRIPTION OF THE DRAWINGS

FIG. 1 is a schematic block diagram of a hybrid electric propulsion system, according to a preferred embodiment of the present invention.

FIG. 2 is a schematic side cross-section view of a vehicle including a flywheel of a hybrid electric propulsion system, according to a preferred embodiment of the present invention.

FIG. 3 is a more detailed schematic block diagram of a hybrid electric propulsion system, according to a preferred embodiment of the present invention.

### DESCRIPTION OF PREFERED EMBODIMENTS

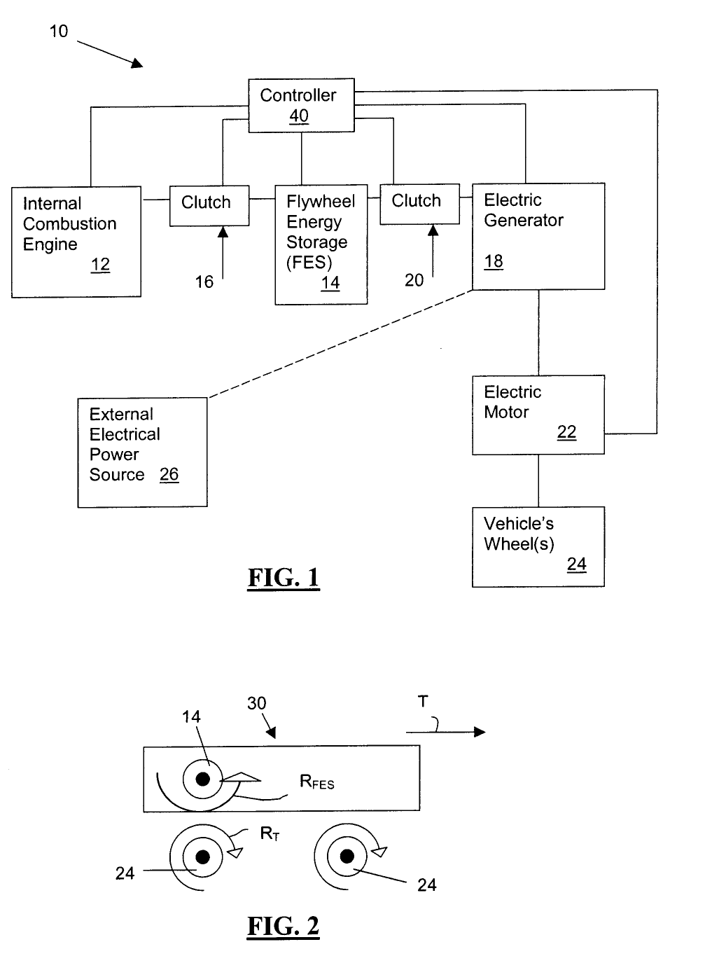

Referring to FIG. 1, there is shown a schematic block diagram of a hybrid electric propulsion system 10 for a vehicle, according to a preferred embodiment of the present invention. The system includes an internal combustion engine 12 operationally connected to a flywheel 14 for storing mechanical kinetic energy, preferably via a magnetic or mechanical clutch 16. An electric generator 18 is also connected to the flywheel 14, preferably via a magnetic or mechanical clutch 20. The clutch 20 may alternatively be an electric clutch or a mechanical clutch or the electric generator 18 may be directly connected to the flywheel 14. Optionally, the flywheel 14 may also be integrated inside the electric generator 18. The electric generator 18 receives power from either the internal combustion engine 12 or the flywheel 14 on demand. The electric generator 18 transfers energy to the vehicle by powering at least one electric motor 22 mechanically connected to the wheels 24 to propel the vehicle.

The electric generator 18 may be connectable to feed points powered by an external electric power source 26 and therefore operates as an electric motor. Several external electric power sources 26, such as feed points, may be located along the itinerary of the vehicle at a certain distance from each other. Each external power source 26 may recharge electrically the mechanical kinetic energy in the flywheel 14 via the electric generator 18 that operates as an electric motor. The connection between the electric power source 26 and the electric generator may be made by means of a mechanical arm that automatically connects to the power source 26. Alternatively, the external electric power source 26 may be a continuous electric link such as electric rails or aerial electric cables, but this would limit the organization of circuits for the vehicle.

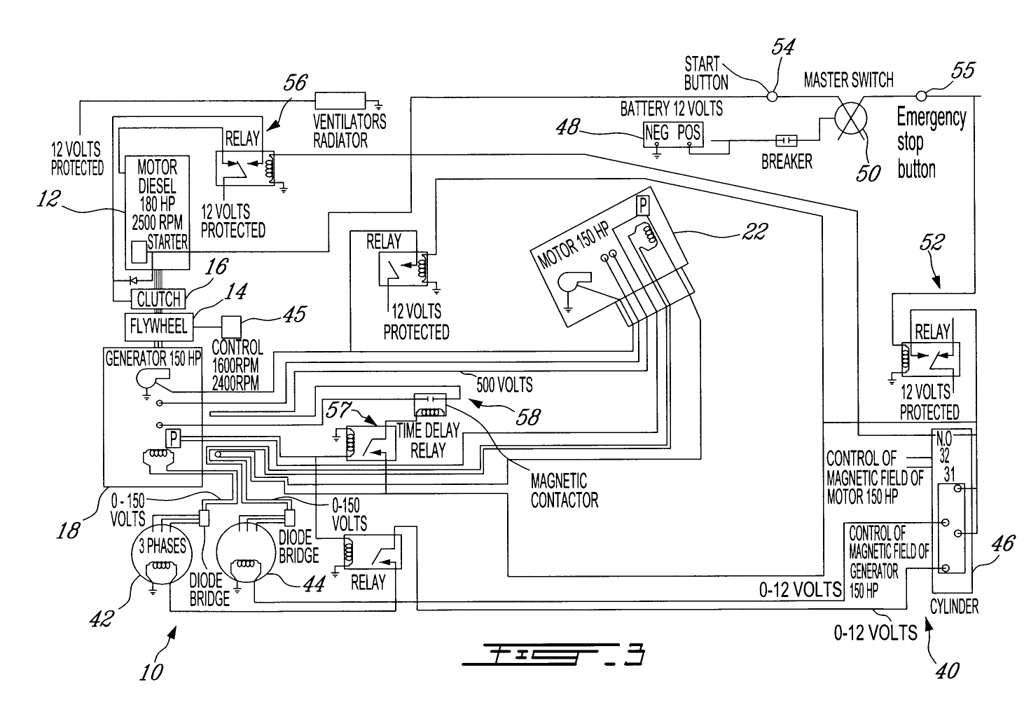

Referring to FIG. 2, there is shown a schematic illustration of a vehicle 30 provided with a hybrid electric propulsion system 10 as shown in FIG. 1. The flywheel 14 has a horizontal rotation axis parallel to the axis of rotation of the wheels of the vehicle 30. In use, when the vehicle 30 travels in a forward direction T, the flywheel 14 is rotatable in an opposite direction R_{FES} with respect to a forward direction of rotation R_{T} of the wheels 24 of the vehicle 30. This direction of rotation R_{FES} of the flywheel 14 is advantageous because it inhibits a rollover effect when the vehicle turns left or right. Indeed, if the flywheel 14 were to rotate in the same forward direction of rotation R_{T} of the wheels 24, in particular when the vehicle is turning left or right, this would cause the vehicle to sway or rollover in an opposite direction. On the other hand, if the flywheel 14 were to have a vertical axis of rotation, this would tend to create a moment pulling the vehicle 30 up or push it down when going up or down a slope. In any case, the use of a flywheel 14 improves the stability of the vehicle 30.

The flywheel 14 may include two counter-rotating disks (not shown), each being driven by counter rotating pinion gears that are in turn connected to a crown gear. By using two counter-rotating disks instead of one disk in the flywheel 14, the gyroscopic effect that is normally not desirable in a vehicle is inhibited. However, if one provides a single rotating disk in the flywheel 14 as described above, then the gyroscopic effect is advantageously used to inhibit a rollover effect of the vehicle when it is turning left or right.

In order to control the above gyroscopic effect, in addition to the main disk, the flywheel 14 may further comprise a secondary disk having a horizontal rotation axis parallel to the rotation axis of the wheels of the vehicle, but rotatable in an opposite direction with respect to the main disk. To maintain the advantage of rollover inhibition, the secondary disk is adapted to store less energy than the first disk. This may be achieved by choosing appropriate relative mass and speed rations of the main and secondary disks.

Referring to FIG. 3, there is shown a more detailed block diagram of a hybrid electric propulsion system 10, according to a preferred embodiment of the present invention. In this example, the internal combustion engine 12 is preferably a 180 HP, which is approximately 135 Kilowatts, Diesel motor rated at 2500 RPM. Of course, for larger vehicles it is preferable to use a greater motor power and for smaller vehicles, it is preferable to use smaller motor power.

The clutch 16 is controlled by a relay, which is in turn controlled by a control system 40, which preferably includes at least one rotatable cylinder defining predetermined control command sequences or by means of the electronic modulating controller.

The flywheel 14 is also connected to a sensor controller 45 that keeps track of its rotation between low and high rotating speed limits, such as 1600 RPM and 2400 RPM. The flywheel 14 is preferably provided with a security system, which in case of failure or accident, prevents flywheel 14 from going out of its emplacement. The security system preferably includes at least two brake bands inside of the flywheel 14 like a brake drum found in several known vehicles and a series of braking shoes adapted to support the brake bands. The brake shoes are provided to support the brake linings. The brake linings may be modified bus or truck brake linings.

To further improve the efficiency of the flywheel 14, it may be housed in a vacuum to diminish the air drag. The flywheel 14 may be supported by magnetic non-friction bearings. The peripheral housing may further provide security from projecting pieces of a flywheel rotating at high speeds and prevents those pieces to fly away to avoid injuries.

Other security systems may be used for the same purpose as described above.

In this example, the electric generator 18 preferably has a maximum power of 150 HP, which is approximately 112 KiloWatts, and is connected to an electric motor 22 also having a maximum power of 150 HP, which is approximately 112 KiloWatts. Both the electric generator and electric motor may be overloaded for short periods of time. Of course, other power ratings may be used according to the particular needs.

Preferably, the controller 40 is a cascade controller that sends variable electric signals to the field coils of the alternators 42, 44 to amplify the signals for controlling the magnetic field of the electric generator 18 and for controlling the magnetic field of the electric motor 22. The alternators 42, 44 are powered mechanically by the electric generator shaft and the field coils are fed from 0 to 12 Volts. The resulting current in the field coils, such as 0 to 4 Amps, is controlled by the multi-stage step controller and/or the electronic modulating controller. The alternators 42, 44 produce correspondingly an output of 0 to 150 Volts depending also on the RPM of the alternators that is conditioned by the RPM of the electric generator 18. Thereby, these alternators 42, 44 are used respectively to control the magnetic fields of the electric generator 18 and the electric motor 22. This particular configuration is advantageous because it provides for a multi-stage step controller and/or an electronic modulating controller to control in cascade the respective field coils of the electric generator 18 and electric motor 22 via alternators 42, 44 that amplify the signals.

Preferably, the step controller 40 includes at least one rotatable cylinder 46 containing predetermined control commands engraved in tracks thereon. The circuits of the step controller 40 may be powered by the vehicle's 12 Volt electric system 48 via a master switch 50 and a relay 52 being secured by an emergency stop button 55. The rotation of the at least one cylinder 46 may be controlled mechanically by acceleration and braking pedals. Alternatively, the acceleration and braking pedals send signals to a electronic modulating controller for achieving the same purpose.

A start button 54 connected to the master switch 50 and to a starter of the Diesel motor 12 is used to start the Diesel motor 12. The Diesel motor 12 is also controlled by the controller 40 via a relay 56. The emergency stop button 55 shuts off the Diesel motor 12 and cuts the power to the relay 52 then cutting completely the signals on either the multi-stage step controller or electronic modulating controller. Simultaneously, the relay 52 cuts off the time delay relay 57, which after a delay switches off the magnetic contactor 58.

In use, the Diesel motor 12 powers the flywheel 14 that stores mechanical kinetic energy therein up to its maximum speed. The Diesel engine 12 is then automatically shut off and the vehicle 30 will run in electric mode. During the electric mode, the flywheel 14 returns the stored mechanical kinetic energy to the electric generator 18 on demand as the driver of the vehicles depresses the accelerator pedal. Once the mechanical kinetic energy in the flywheel 14 is diminished down to a lower threshold, the system goes back to Diesel mode and the Diesel motor 12 powers the electric generator 18 via the shaft of the flywheel 14 while recharging the flywheel 14. In this manner, when the Diesel motor 12 is turned on, it is always actively and efficiently working, and is never running idle. The Diesel motor 12 is controlled in such a manner that it works in its optimal region of operation to reduce its energy consumption and achieve its maximum energy efficiency. Thus, the Diesel motor 12 produces minimum amounts of green house gases and atmospheric pollutants. Of course, when the vehicles runs on all electric power then there is maximum energy efficiency, no green houses gases produced, no atmospheric pollutants and the lowest consumption of energy. For example, when the flywheel 14 reaches its maximum speed, such as 2400 RPM, then the Diesel motor 12 is shut off. When the speed of the flywheel 14 diminishes to the lower rotation speed limit of about 1600 RPM, then the Diesel motor 12 will be turned back on by the controller sensor 42.

When the driver of the vehicle depresses the brake pedal, which may also be termed a deceleration pedal, then the Diesel motor 12 shuts off automatically and the kinetic energy of the moving vehicle 30 is transformed into electric energy by the electric motor 22, which now functions as an electric generator. Therefore, the electric motor 22 powers the electric generator 18, which now functions as an electrical motor. The electric generator 18 transforms the electric energy back into kinetic energy as it drives and reenergizes the flywheel 14.

Similarly, when the vehicle 30 goes down a slope the potential energy is also recuperated by regeneration via the electric motor 22 and the electric generator 18, and stored into the flywheel 14 as mechanical kinetic energy.

The vehicle 30 may be provided with additional energy storage systems such as compressed gas, air or vapor systems, spring systems, hydraulic systems, heat recovery systems, pressure systems, capacitor systems, electrical systems, or battery systems. For example, if the stored energy in flywheel has reached its maximum as it is rotating at 2400 RPM then the excess energy recuperated during a deceleration may be stored in the additional energy storage systems.

Advantageously, a quasiturbine may be provided as an option to the Diesel motor 12.

In experimental applications, a vehicle using a hybrid electric propulsion system according to the present invention consumes about 1 Kilowatt-hour per kilometer in normal urban operations. If such vehicle travels about 200 kilometers per day then the total energy requirement is 200 Kilowatt-hours. If one uses a Diesel motor of 180 HP, which is approximately 135 Kilowatts, then such motor needs to run at its optimum operation range for about 2 hours during a 20 hour operation of the vehicle.

The flywheel 14 may be reenergized typically in less than 20 seconds between feed points either by the Diesel motor 12 or by the feed points connected to external power sources 26 that are located at about 300 meters apart from each other. The feed points connected to external power sources 26 are typically connected to the local electric network.

Preferably, the system includes heat recuperation systems to recover all heat energy produced in the vehicle such as by the exhaust systems, air conditioning systems, radiators, motors, generators, alternators, etc. In actual vehicles normally all the heat is lost if not used to warm up the passenger compartment.

The vehicle may also include solar cells on its roof and/or around the sides of the vehicle that may feed the hybrid electric system.

The hybrid electric propulsion system of the present invention has many advantages. It is relatively inexpensive to build, to sell, to operate and to maintain. It produces less noise than traditional vehicles an is therefore more comfortable for its users. It also achieves higher accelerations and its combustion engine is subject to lesser wear and therefore lasts longer. The decelerations are more secure because they are made by three types of braking: the regenerative braking as described above, dynamic braking using resistances to dissipate kinetic energy into heat, and standard pneumatic braking. The dynamic braking which uses resistances may be connected to a heat recuperation system for recuperating the heat energy dissipated by the resistances.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

1. A hybrid electric propulsion system for driving at least one traction wheel of a vehicle, the system comprising:
an internal combustion engine (12);
a flywheel (14) operatively connected to the internal combustion engine for storing mechanical kinetic energy, the flywheel (14) having a horizontal rotation axis parallel to a rotation axis of the wheels of the vehicle, the flywheel having a single disk being rotatable in an opposite direction (R_{FES}) with respect to a rotation of the wheels (R_{T}) of the vehicle when the vehicle is travelling forward so as to inhibit a rollover effect of the vehicle when the vehicle is turning;
an electric generator (18) operatively connected to the flywheel (14);
an electric motor (22) operatively connected to the electric generator (18); and
a controller for controlling operation of the engine (12), the flywheel (14), the electric generator (18) and the electric motor (22).

2. The hybrid electric propulsion system of claim 1, wherein the electric generator (18) is connectable to feed points powered by an external electric power source (26).

3. The hybrid electric propulsion system of claim 1, further comprising:
a first alternator (42) having first field coils for controlling a magnetic field of the electric generator (18);
a second alternator (44) having second field coils for controlling a magnetic field of the electric motor (22); and
wherein the controller (40) controls in cascade a first current in the first field coils of the first alternator (42) and a second current in the second field coils of the second alternator (44).

4. The hybrid electric propulsion system of claim 3, wherein the controller (40) includes a multi-stage step controller having at least one rotatable cylinder (46) defining predetermined control command sequences.

5. The hybrid electric propulsion system of claim 1, wherein the controller includes an electronic modulating controller.

6. (canceled)

7. The hybrid electric propulsion system of claim 1, further comprising a security system including at least two brake bands inside of the flywheel (14) and a series of braking shoes adapted to support the brake bands.

8. The hybrid electric propulsion system of claim 1, further comprising additional energy storage systems selected from the group of compressed gas, air or vapor systems, spring systems, hydraulic systems, heat recovery systems, pressure systems, capacitor systems, electrical systems, and battery systems.

9. The hybrid electric propulsion system of claim 1, further comprising heat recuperation systems to recover heat energy produced in the vehicle via exhaust systems, air conditioning systems, radiators, motors, generators, and alternators.

10. A hybrid electric propulsion system for driving at least one traction wheel of a vehicle, the system comprising:
an internal combustion engine (12);
at least one flywheel (14) operatively connected to the internal combustion engine (12) for storing mechanical kinetic energy;
an electric generator (18) operatively connected to the flywheel (14);
a first alternator (42) having first field coils for controlling a magnetic field of the electric generator (18);
an electric motor (22) operatively connected to the electric generator (18);
a second alternator (44) having second field coils for controlling a magnetic field of the electric motor (22); and
a controller (40) for controlling in cascade a first current in the first field coils of the first alternator (42) and a second current in the second field coils of the second alternator (44).

11. The hybrid electric propulsion system of claim 10, wherein the controller includes a multi-stage step controller.

12. The hybrid electric propulsion system of claim 11, wherein the multi-stage step controller includes at least one rotatable cylinder defining predetermined control command sequences.

13. The hybrid electric propulsion system of claim 10, wherein the controller includes an electronic modulating controller.

14. The hybrid electric propulsion system of claim 10, wherein the flywheel (14) has a horizontal rotation axis parallel to a rotation axis of the wheels of the vehicle, the flywheel having a main disk being rotatable in an opposite direction (R_{FES}) with respect to a rotation of the wheels (R_{T}) of the vehicle when the vehicle is travelling forward so as to inhibit a rollover effect of the vehicle when the vehicle is turning.

15. The hybrid electric propulsion system of claim 14, further comprising a secondary disk having a horizontal rotation axis parallel to the rotation axis of the wheels of the vehicle and rotatable in an opposite direction with respect to the main disk so as to inhibit a gyroscopic effect in the vehicle, and wherein the secondary disk is adapted to store less energy than the first disk so as to control the rollover effect.

16. A hybrid electric propulsion system for driving at least one traction wheel of a vehicle, the system comprising:
an internal combustion engine (12);
a flywheel (14) operatively connected to the internal combustion engine for storing mechanical kinetic energy, the flywheel (14) having a horizontal rotation axis parallel to a rotation axis of the wheels of the vehicle, the flywheel having a main disk being rotatable in an opposite direction (R_{FES}) with respect to a rotation of the wheels (R_{T}) of the vehicle when the vehicle is travelling forward so as to inhibit a rollover effect of the vehicle when the vehicle is turning, the flywheel further comprising a secondary disk having a horizontal rotation axis parallel to the rotation axis of the wheels of the vehicle and rotatable in an opposite direction with respect to the main disk so as to inhibit a gyroscopic effect in the vehicle, and wherein the secondary disk is adapted to store less energy than the main disk so as to control the rollover effect;
an electric generator (18) operatively connected to the flywheel (14);
an electric motor (22) operatively connected to the electric generator (18); and
a controller for controlling operation of the engine (12), the flywheel (14), the electric generator (18) and the electric motor (22).

17. The hybrid electric propulsion system of claim 16, wherein the electric generator (18) is connectable to feed points powered by an external electric power source (26).

18. The hybrid electric propulsion system of claim 16, further comprising:
a first alternator (42) having first field coils for controlling a magnetic field of the electric generator (18);
a second alternator (44) having second field coils for controlling a magnetic field of the electric motor (22); and
wherein the controller (40) controls in cascade a first current in the first field coils of the first alternator (42) and a second current in the second field coils of the second alternator (44).

19. The hybrid electric propulsion system of claim 18, wherein the controller (40) includes a multi-stage step controller having at least one rotatable cylinder (46) defining predetermined control command sequences.

20. The hybrid electric propulsion system of claim 19, wherein the controller includes an electronic modulating controller.

21. The hybrid electric propulsion system of claim 16, further comprising a security system including at least two brake bands inside of the flywheel (14) and a series of braking shoes adapted to support the brake bands.
